(19) United States
(12) Patent Application Publication
(10) Pub. No.: US 2012/0314403 A1
(43) Pub. Date: Dec. 13, 2012

(54) LONG RANGE MULTI-FUNCTION ILLUMINATION DEVICE AND METHOD OF USE

(75) Inventors: Jeffrey P. Kennedy, San Juan Capistrano, CA (US); Gary Palmer, Carlsbad, CA (US)

(73) Assignee: XENONICS HOLDINGS, INC., Carlsbad, CA (US)

(21) Appl. No.: 13/155,453

(22) Filed: Jun. 8, 2011

(51) Int. Cl. F21V 33/00

(52) U.S. Cl. 362/109

(57) ABSTRACT

A long range illumination system includes a handheld illumination device, includes a housing having an elongated body and a head coupled to one end. A switch disposed on an outer surface of the housing receives an input from a user. At least one power source supplies electrical power to the handheld illumination device. A lamp produces high intensity light for illumination. The lamp is disposed within a parabolic reflector having an aperture and movable about an optical axis of symmetry relative to the lamp for projecting a high intensity beam. A green optical filter moveably mounted to the head is substantially covers an end of the reflector in a first position, and does not cover the end of the reflector in a second position. A processor is configured to receive the input signal and causes an output power level to said lamp based on the input signal.

### FIELD OF THE INVENTION

This application relates to long-range illumination devices.

### BACKGROUND OF THE INVENTION

In 1995, the United Nations issued the Protocol on Blinding Laser Weapons which banned the use of laser systems or weapons capable of causing permanent blindness to unenhanced vision (i.e. the naked eye). However, tactical operations in military, law enforcement and security are aided by the ability to disrupt, confuse, or temporarily blind a perceived threat. For example, a driver approaching a check point who refuses to stop requires intervention at a sufficient distance to ensure safety to personnel and facilities. The ability to disrupt the vision or attention of the driver, particularly at a significant distance, provides a valuable tool in providing protection to personnel, equipment and facilities.

Intense light, particularly visible light having a wavelength in the green spectrum ranging from about 495 nm (nanometers) to about 570 nm, is effective in causing biological effects when viewed. These effects include temporary blindness, discomfort, and confusion. As a result, non-lethal weapons known as dazzlers have been developed to provide intense green light beams. Dazzlers utilize green lasers (emitting radiation with a wavelength 532 nm±10 nm) to produce an intense beam of green light which, when directed at a person, disrupts that person's ability to see or concentrate. Typical lasers, such as those used in laser pointers, are designed to project a concentrated light beam over great distances. Lasers often have an nominal ocular hazard distance (NOHD) associated with them, representing the safe distance for the human eye from the laser so as not to sustain permanent damage such as blindness. Dazzlers often are configured to provide slight divergence of the beam which provides a greater NOHD than, for example, a laser designed as a pointer. However, many lasers still have the inherent ability to cause permanent blindness. For this reason, the provision of dazzlers is carefully managed and limited to military and law enforcement organizations. Even in these circles, the use of dazzlers requires a high level of personnel training and instruction in the safe use of lasers for non-lethal purposes complying with the United Nation's Protocol on Blinding Laser Weapons.

### SUMMARY

A long range illumination device includes a housing. The housing has an elongated body and a head portion at one end of the body. A switch is disposed on an outer surface of the housing for receiving an input from a user and is in electrical communication with a processor within the housing. At least one power source is provided for supplying electrical power to the handheld illumination device. A lamp within the head portion produces high intensity light energy which is projected from the end of the illumination device. A parabolic reflector surrounds the lamp and has an aperture through which the lamp extends. The parabolic reflector is movable about an optical axis of symmetry relative to the lamp allowing for adjustment of the projected high intensity light beam. A green optical filter is provided and is moveably mounted to the head portion of the housing and may be positioned to substantially cover an end of the parabolic reflector in a first position in which the optical filter blocks at least a portion of the projected beam. Alternatively, the green optical filter may be positioned to not cover the end of the parabolic reflector in a second position in which the projected beam is not blocked by the optical filter.

A processor in electrical communication with the switch receives at least one input signal and produces an output control signal based on the at least one input signal. A power supply circuit is responsive to the output control signal and provides an output power level to the lamp based on the input signal. The output power level may be a high power level or a low power level. The power supply circuit may be configured to provide a constant output power level to the lamp to produce a steady output light level, or may be configured to cycle between a high output light level and a low output light level to produce a pulsed mode of operation.

A method for providing long range illumination includes receiving an input signal indicative of a mode of operation. An output power signal is generated, the output power signal operative to control an output power level to a lamp. A constant output power level is provided to the lamp during a first mode of operation, and the output power level is cycled between a high output power level and a low output power level in a second mode of operation. The light energy produced by the lamp is focused using a parabolic reflector to produce a high intensity light beam which is projected through a green optical filter when the green optical filter is in a first position which at least partially blocks the projected light beam, and projected unfiltered when said green optical filter is in a second position which does not block the projected light beam.

### BRIEF DESCRIPTION OF THE DRAWINGS

FIG. 1 is a schematic block diagram of a long-range illumination system

FIG. 2A is a perspective view of an exemplary embodiment of a long-range illumination device with an optical filter;

FIG. 2B is a perspective view of the long-range illumination device of FIG. 2A;

FIG. 3 is a perspective exploded view of the long-range illumination device shown in FIG. 2A and FIG. 2B;

FIG. 4 is a partial section elevation view of a lamp assembly for a long-range illumination device;

FIG. 5 is a plan view of a printed circuit board for use in a long-range illumination device;

FIG. 6A-6C are elevation views of embodiments of a lens and filter assembly according to embodiments of a long-range illumination device; and

FIGS. 7A-7C are perspective views of a lens and optical filter assembly according to an embodiment of a long-range illumination device;

FIG. 8 is a perspective view of an optical filter and filter ring mount for use with an exemplary embodiment of a long-range illumination device;

FIG. 9 is a process flow diagram for a method of use of a long range illumination device.

### DETAILED DESCRIPTION

With regard to many military and law enforcement missions, personnel perform reconnaissance, recovery, or tactical operations, for various reasons (e.g. surprise or stealth), at times when light levels are low or times of total darkness. For missions involving the non-lethal escalation of force, the mission objectives may be characterized as: Detect, Delay, Deny, Defeat and Destroy. Detecting a threat or enemy, particularly in low or no light conditions, requires illumination devices that allow personnel to see and detect the threat or enemy at long ranges, for example, ranges extending thousands of meters. To provide this level of illumination, searchlights may utilize arc lamps, for example xenon arc lamps, to provide white light illumination with an illuminated field of vision extending up to greater than 1500 meters. As arc lamps generally emit radiation throughout the visible spectrum and in portions of the ultraviolet and infrared spectra, further visibility may be obtained using infra-red filters, which provide greater illumination range and lower risk of detection in low light conditions, or ultra-violet filters that provide the ability to fluoresce objects for marking targets.

An embodiment of a multi-purpose, long-range illumination device described herein provides, in a single device, the ability to achieve all three objectives of detecting, delaying and denying an opponent. Through the use of optical filters and electronic control of lamp illumination technology, a single device that provides long range illumination for detection may be quickly adapted in the field to from a searchlight mode to a pulsed filtered mode, which may also be referred to as a dazzler mode, providing a high intensity beam of light that may be pulsed at a controlled frequency and filtered to provide disruptive physiological effects in a detected target.

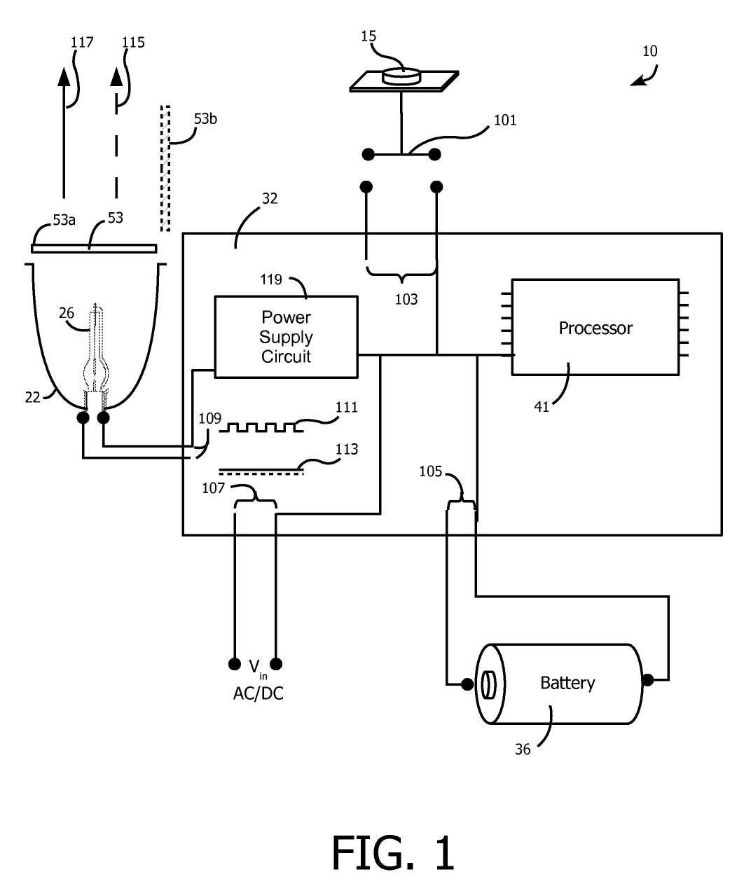

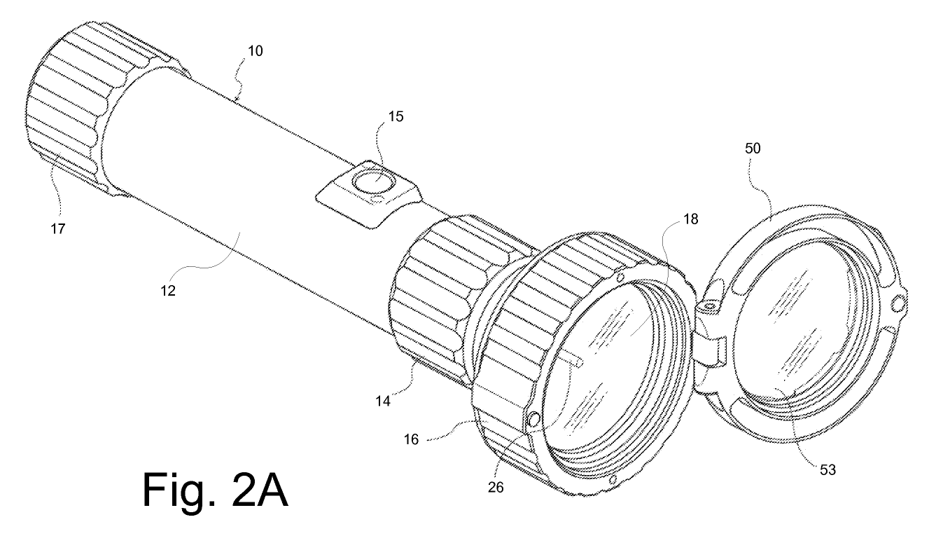

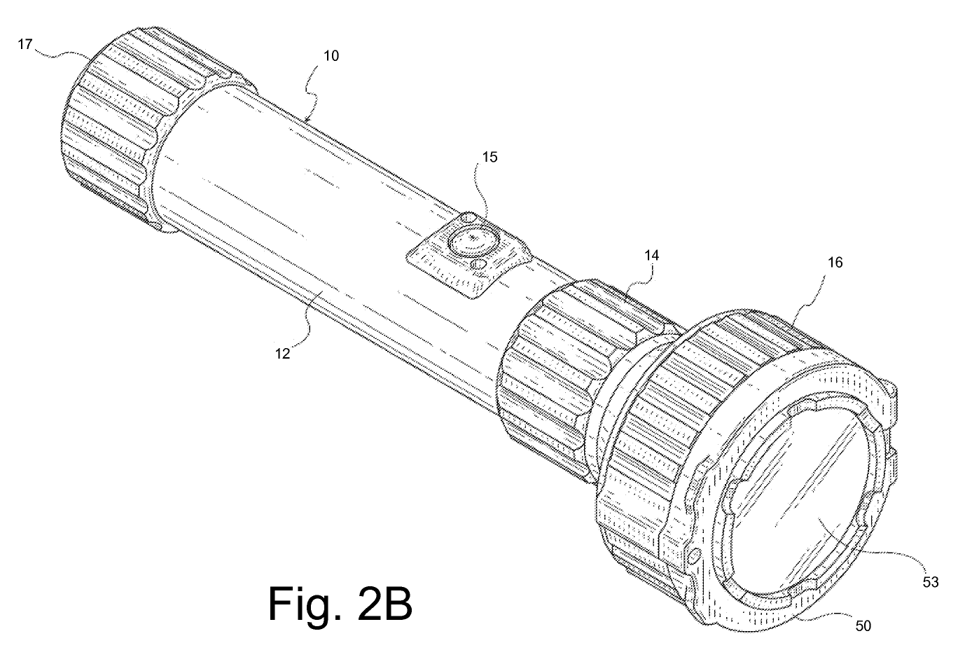

FIG. 1 is a schematic illustration of a multi purpose, long range illumination device 10. Illumination device 10 includes a user interface for receiving input from a user. The user interface may include a switch 15. By way of example, switch 15 may be a pushbutton switch which is accessible to a user holding the handheld illumination device 10 of FIG. 2a. Referring again to FIG. 1, responsive to a user pressing the switch 15, an electrical switch contact 101 operates to close switch input contacts 103. In one embodiment, the switch 15 and switch contact 101 are momentary contacts creating a closed circuit across switch input contacts 103 which are in electrical contact with printed circuit board (PCB) 32, for as long as a user keeps switch 15 depressed. Upon releasing switch 15, switch contacts 101 separate from switch input contacts 103 and the circuit opens. A processor 41 is in electrical communication with contacts 103 and receives an input signal based on the operation of switch 15. Based on the input signal, processor 41 provides output signals used to provide control of circuitry on printed circuit board (PCB) 32. For example, pressing and releasing switch 15 provides a momentary closure between switch input contacts 103. A momentary closure (i.e. closure for less than a threshold time, e.g. 0-5 seconds), may be interpreted by the processor 41 to indicate a command to power on or power off the illumination device 10. If the current power state of the device 10 is on, the signal is indicative to the processor 41 to turn the device 10 off. Conversely, if the current power state of the device 10 is off, a momentary closure across switch input contacts 103 is indicative to processor 41 to turn the device 10 on. The processor 41 generates an output power signal which is operative to control circuitry on PCB 32. For example, the output power signal may be used to control power supply circuit 119 which provides an output power level to a lamp 26.

The illumination device 10 may function in a number of modes of operation. By way of example, the illumination device 10 may operate in a continuous light mode of operation. In a continuous light mode, the illumination device emits a continuous and steady intensity light beam. When in continuous light mode, the illumination device is well suited for illuminating an area at which the continuous light beam is directed. For this reason, the continuous light mode, may also be considered a searchlight mode or night vision mode. In a searchlight mode, the continuous light beam may be emitted without a filter, providing a white light which illuminates a targeted area. If the illumination device utilizes an infrared filter, which emits a continuous light beam of infrared light, the illumination device operates in an infrared night vision mode. In another mode of operation, the processor 41 may send control signals to the power supply circuit 119 which cause the power supply circuit 119 to provide output power to the lamp 26. The output power alternates between a high power level and a low power level at a predetermined frequency. The alternating output power causes the lamp 26 to emit an alternating high intensity light beam and low intensity light beam, providing the illumination device 10 with a pulsed mode of operation. As dazzler devices also utilize pulsed light to achieve their desired effect, the pulsed mode of operation may also be referred to as a dazzler mode. The pulsed mode may be operated in a non-filtered state, in which a white light strobe is emitted from the illumination device 10, or in an alternative embodiment, an optical filter, for example, a green optical filter may be used to filter the pulsed light beam to provide a green strobe.

If the user presses and holds switch 15 down for a predetermined period of time (e.g. longer than two seconds), the extended closure of switch input contacts 103 may act to provide an input signal to processor 41 operative to initiate a programmed mode of operation of the illumination device 10. For example, when a user presses and holds switch 15 for more than two seconds, processor 41 may be configured to generate an output power signal to power supply circuit 119 operative to provide an output power level to a lamp 26 causing the lamp 26 to operate in a pulsed mode.

The illumination device 10 includes at least one power supply that provides electrical power to the illumination device 10. For example, a battery 36 may provide direct current (DC) voltage to the illumination device 10. Battery 36 may be situated inside the housing 11 (shown in FIG. 2a) and electrically connected to PCB 32 through battery contacts 105 providing an internal power source. In addition to, or instead of, battery 36, an external power source may be electrically connectable through external power contacts 107 to PCB 32. The external power source may be a DC or alternating current (AC) voltage applied to external power contacts 107 to provide electrical power to the illumination device 10. The external power source may further be used to provide electrical power to charge battery 36 when both a battery 36 and an external power source are available. A range of external voltage levels may be applied to external power contacts 107. The received voltage may be rectified (i.e. converted from AC to DC), regulated, or conditioned using circuitry disposed on a substrate of PCB 32. PCB 32 may include processor 41 which may receive and process instructions for control of the voltage control circuitry. By way of example, processor 41 may be configured to provide output control signal to control battery charging circuitry to ensure that proper voltage is provided to battery 36 to maintain a charge during times when an external power source is available.

Processor 41 is configured to provide control signals to power supply circuit 119 for providing output power levels to a lamp 26 which is electrically connected to PCB 32 through lamp contacts 109. Lamp 26 is a high intensity lamp providing an intensity level that is a function of the electrical power level received by lamp 26 across lamp contacts 109. Lamp 26 is configurable to provide a high or low light intensity level based on the output power generated by power supply circuit 119 and applied across lamp contacts 109. As described above, responsive to an input signal generated by the closing of switch input contacts 103 by a user depressing switch 15, processor 41 may output one or more control signals for controlling power supply circuit 119. The illumination device 10 may be in a power state of on, wherein output power is supplied to lamp 26 and the lamp 26 is illuminated. A power state of off is a state in which output power is not supplied across lamp contacts 109 and lamp 26 is not illuminated. Although the lamp 26 is not illuminated during an off power state, other components of the illumination device 10 may be receiving power. For example, a battery charging circuit or a standby control circuit may still be supplied with power although the power state of the system is off. The processor 41 may be in an awake state, or in a power saving or sleep state. When the current power state of the illumination device 10 is off, a momentary closure of switch input contacts 103 indicates to processor 41 to change the illumination device 10 power state to on. Processor 41 provides a signal that is operative to cause an igniter (not shown) to initiate lamp 26, and sends a power control signal to power supply circuit 119 electrically connected to lamp contacts 109. The control signal is operative to cause the power supply circuit 119 to apply a constant DC voltage 113 to lamp contacts 109. The constant DC voltage 113 passes through lamp 26 causing lamp 26 to output a steady high intensity light. The high intensity light is reflected by a parabolic reflector 22 placed around lamp 26. The light energy from lamp 26 is focused and projected in a direction forward of the illumination device as a continuous beam 117. Lamp 26 may emit radiation through the visible spectrum and at least in portions of the infrared and ultraviolet spectra adjoining the visible spectrum. When the current power state of the illumination device 10 is on and a user depresses switch 15 for longer than a predetermined time period, the extended closure of switch input contacts 103 indicates to processor 41 to enter a pulsed mode of operation. Processor 41 sends an output power signal to power supply circuit 119. The output power signal is operative to cause the power supply circuit 119 to apply an output power level that cycles between a high output power level and a low power output level 111 to lamp contacts 109. The periodic DC voltage 111 causes lamp 26 to output a pulsing high intensity light as the power supplied to lamp 26 cycles between high power and low power. The pulsing high intensity light is reflected by a parabolic reflector 22 positioned around lamp 26. The light energy from lamp 26 is focused and projected in a direction forward of the illumination device 10 as a pulsing light beam 115.

A green optical filter 53, for example, a bandpass filter that allows light having wavelengths in the green portion of the visible spectrum to pass through while other wavelengths are absorbed or blocked, placed in a position 53a which covers the end of parabolic reflector 22, results in the continuous light beam 117 or flickering light beam 115 appearing green. Green optical filter 53 is moveable to allow the green optical filter 53 to be placed in a second position 53b in which green optical filter 53 does not cover the end of parabolic reflector 22 and is clear of the light beam 115, 117, thereby projecting an unfiltered continuous light beam 117 or an unfiltered pulsing light beam 115.

The processor 41 has inputs and outputs (not shown) which receive inputs from other components, for example, the pushbutton switch 15, and process the inputs to provide outputs for control of the multi-purpose, long range illumination device 10. The processor 41 may be programmed to detect power and voltage levels from battery contacts 105 and/or external power contacts 107 and provide output signals that cause components to operate to provide power conversion, conditioning, charging and/or control. For example, processor 41 may be programmed to detect a voltage level of an external power source across external power contacts 107 and provide output control signals to power supply circuit 119 to convert the voltage to a voltage appropriate for lamp 26. In this way, external voltages that span a range of voltage levels may be converted to the proper operating voltage to power lamp 26. In addition, processor 41 may control battery charging circuitry (not shown), for charging battery 36 when an external power source is detected at external power contacts 107 and disconnecting the battery power to the illumination device 10 when an external voltage source is sensed.

Lamp 26 may be an arc lamp, for example, a xenon arc lamp. Arc lamps require an initial high voltage pulse to excite the plasma within the lamp 26 and provide an ignition arc across a pair of electrodes. The processor 41 may be configured to control igniter circuitry (not shown) providing a momentary high voltage pulse to lamp 26 responsive to receiving a signal to power on the lamp 26. The high voltage pulse provides initial ignition of the lamp 26.

Processor 41 may further control power supply circuit 119 which controls the intensity of the output of lamp 26. Lamp power levels may be controlled to provide a high power level providing a high intensity level of lamp 26, or a low power level for providing a low intensity level of lamp 26. In a pulsed mode of operation, the lamp 26 may be provided power that cycles between the high power level and low power level causing the lamp 26 to alternate from high intensity to low intensity gradually and periodically, thereby causing viewers of the projected beam to perceive a pulsing or strobe effect. The processor 41 may access one or more memory devices that store code including software instructions that cause processor 41 to provide control signals to control the frequency of the cycling between high and low power to the lamp 26 and therefore, the frequency of pulsing beam 115. For example, to provide a strobe effect that when used in combination with a green optical filter causes illumination device 10 to operate as a green dazzler that flickers at a frequency in a range of about 13 to about 30 Hz (hertz), the processor 41 may be programmed to provide control signals to power supply circuit 119 to cause the power supply to cycle between a high power and a low power beam output at a continuous frequency ranging from 13 to 30 times per second.

Inputs received from the operation of pushbutton switch 15 may be interpreted by the processor 41 to provide one-touch functionality for implementing multiple modes of operation of the illumination device 10. For example, beginning with the illumination device 10 powered off, a momentary press and release of pushbutton switch 15 may send an input signal to the processor 41 to initiate a power-on process. Processor 41 provides an output signal to an igniter circuit which pre-heats and ignites lamp 26. After ignition, processor 41 provides control signals to power supply circuit 119 to output a constant DC voltage 113 to maintain illumination of the lamp 26. If the device 10 is in a powered-on state and the pushbutton switch 15 is momentarily pressed and released, processor 41 provides a control signal to power supply circuit 119 to cease providing power to the lamp 26. Once power is no longer provided to lamp 26, the long range illumination device 10 changes to an off state. Although no light is being generated by the lamp 26, during off state, processor 41 may continue to operate, e.g., to sense input voltage levels from the battery 36 via battery contacts 105 and an external power source via external power contacts 107.

If the illumination device 10 is powered on and the pushbutton switch 15 is pressed and held for longer than a pre-determined length of time (e.g. more than two seconds), an input signal is sent to processor 41 indicative of the user's intention to change device 10 to a pulsed mode. The input signal is received by processor 41, and the processor 41, responsive thereto, generates an output power signal to power supply circuit 119 which causes power supply circuit 119 to generate an output power level resulting in light emitted from lamp 26 cycling repeatedly between high-intensity and low-intensity at a pre-determined frequency. The lamp 26 continues to cycle between a high intensity beam and a low intensity beam at the predetermined frequency until the user releases switch 15. When the user releases pushbutton switch 15, the device may be configured to return to a constant power level in an on state.

The processor 41 may be configured to cause the illumination device 10 to provide a pulsing light at a frequency in a range of about 13 to about 30 Hz, which by way of example, may correspond to beta brain waves. In an embodiment, the device may be configured to pulse at a frequency of 15 Hz. In another embodiment, the processor 41 may be configured to cause the illumination device 10 to provide a pulsed light at a frequency of 8 to 30 Hz. Alpha brain waves between 8 and 13 Hz are generated by the brain when the subject is awake, but in a lowered state of alertness.

Referring to FIGS. 2A and 2B, perspective views of an exemplary embodiment of the multi-purpose long range illumination device 10 of FIG. 1 are shown. The illumination device 10 has an elongated body 12. The body 12, may be adapted to serve as a grip by which a user handles the device 10 or alternatively, a mounting hole (not shown) may be provided in body 12 for mounting on another device, such as a tripod, a rifle sight, or a night vision telescope or imaging device. In an alternate embodiment, an external handle (not shown) may further be provided either as an integrated part of body 12, or as a discrete component attached to body 12. Body 12 may be cylindrical with a hollow interior space which may house a battery, wiring, or control circuitry used to regulate and control power to the multi-function, long-range illumination device 10, or provide other control functions relating to the usage of multi-function, long-range illumination device 10. For example, the processor 41 and power supply circuit 119 (shown in FIG. 1) may be housed in body 12.

A switch 15 is disposed on body 12 which may be used to provide user input to a control device (e.g. processor) of the device 10, for powering the device 10 on or off, or to provide other user input necessary for entering various modes of operation. The switch 15 may be adhered to the outer surface of body 12 and operate magnetically on an actuator inside body 12, providing switching functionality without the need for openings in the body 12, or the switch 15 may be mounted on the body 12, and operate through one or more openings provided in the wall of body 12. The use of a magnetic switch with no associated opening in body 12 provides added integrity to the body 12, preventing the entry of foreign material, for example, sand or water, into the interior of body 12.

A head 14 portion is connected to one end of the body 12 and contains a lamp assembly (which includes lamp 26 and parabolic reflector 22 of FIG. 1) that generates a light beam and directs the beam forward of the device 10 in the direction opposite the body 12. Inside the head 14, a lamp 26 (shown in FIG. 1), for example an arc lamp, generates light energy through an electrical arc passing through a ball of ions contained within the lamp. The lamp is situated within head 14 and is positioned along the axis of a reflector which reflects and collimates the light energy generated by the lamp, directing the light energy in a direction forward of the illuminating device 10. The reflector has an optical axis of symmetry along which the lamp is positioned. To provide varying beam width, from a narrow spot to a wide flood light, the reflector is moveable along the optical axis of symmetry relative to the lamp, providing the ability to focus the light beam to provide a narrow or wide beam based on the relative position of the reflector with respect to the lamp.

A bezel 16 covers the end of the head 14 opposite the body 12. The bezel 16 may be threaded onto the end of head 14 and may be coupled to the reflector to provide relative motion between the reflector and the lamp when the bezel is rotated about the longitudinal axis of the device 10. A lens 18 may be provided at the forward end of the device 10 in the direction of the projected light beam. The lens 18 may be secured by bezel 16 when the bezel 16 is threaded onto the head 14.

At the rearward end of the body 12, opposite head 14, an end cap 17 is provided. The end cap 17 may be threaded onto the body 12 end with a seal provided between end cap 17 and body 12 for example, an O-ring or gasket, to provide protection of the interior of body 12 from external substances such as water, dirt or sand. The end cap 17 may serve to retain a battery located within body 12, and may additionally be configured to provide an electrical connection to an external power source. The external power source may provide electrical power to power the illumination device 10, or may further provide electrical power to charge an internal battery. End cap 17 may be equipped with an electrical connector through end cap 17 for receiving a terminal end from an external power source. A removable plug made of a resilient material may be inserted in the electrical connector port when not in use. In another embodiment, the end cap 17 may be configured to inductively receive an electric potential from an external power source without the need for an opening in end cap 17.

An additional optical filter 53 may be placed over lens 18 to filter the light beam as it exits the illumination device 10. The optical filter 53 may filter certain wavelengths of light, letting only a selected bandwidth of wavelengths to pass through the optical filter 53. For example, optical filter 53 may be an infrared optical filter that passes wavelengths only in the infrared (IR) spectrum. Isolating IR light provides greater visible range of the device 10 in low light conditions and also makes a user harder to detect. In another embodiment, an optical filter 53 which only allows ultraviolet (UV) light to pass through the filter 53 and blocks longer wavelengths such as visible and IR light is used. UV light may be used to fluoresce certain objects on which it is projected, providing better visibility of these objects.

Illumination device 10 may include features disclosed in U.S. Patent Application Publication No. 2010/0033961 assigned to Xenonics Holdings, Inc. of Carlsbad, Calif. which is herein incorporated by reference in its entirety as if fully set forth, including by way of non-limiting example, the rotatable bezel 16, filter ring 81, and filter ring mount 50 described therein. The optical filter 53 may be held by a filter ring mount 50 which is movably attached by a hinged mechanism to bezel 16. As shown in FIG. 1A, the optical filter 53 is at a position that is at 180° with respect to the lens 18. In this position, no portion of the optical filter 53 covers lens 18 and an emitted light beam projected through lens 18, passes untouched by optical filter 53.

Referring now to FIG. 2B, the illumination device 10 according to this embodiment is shown with optical filter 53 positioned such that the optical filter 53 completely covers lens 18. When positioned as shown in FIG. 2B, a projected light beam passes through lens 18 and optical filter 53, causing the light beam to be filtered according to the filtering properties of the optical filter 53. The optical filter may be alternately positioned between the position shown in FIG. 2A and the position shown in FIG. 2B

In a multi-purpose long range illumination device, the optical filter 53 may block all light wavelengths except those in the visible light spectrum characterized as green light. Green light is light having wavelengths, for example, of 495 to 570 nm. Optical filter 53 may be a bandpass filter which passes a range of wavelengths centered on, for example, a wavelength of 532 nm. Utilizing a green optical filter, the multi-purpose, long-range illumination device 10 may be converted from a searchlight mode of operation providing a steady high-intensity white light beam to an alternate mode of operation providing a steady or pulsed high intensity green light beam simply and quickly in the field by placing and removing the green optical filter from the path of a projected beam. This provides the objectives of detecting, delaying and denying a potential threat using a single device.

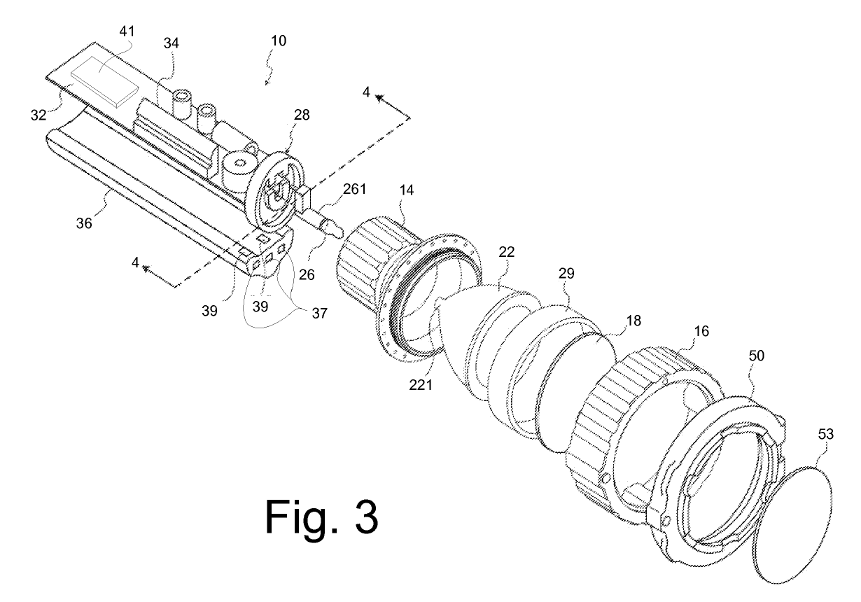

FIG. 3 is an exploded view of a multi-purpose, long range illumination device 10, illustrating some of the device's internal components. At the forward end of the device 10, located within the head 14 is a parabolic reflector 22, having an aperture 221 for receiving a lamp 26. The lamp 26 is integrated in a lamp assembly 261 which is configured to engage with lamp socket assembly 28 through a pair of pin electrodes arranged within a lamp base having a geometric shape that mates with a recess in lamp socket assembly 28 in only one possible direction. This allows for replacement of the lamp 26 in the field, and ensures proper installation of the lamp 26, positioning the lamp 26 in the optical axis of symmetry of parabolic reflector 22. Parabolic reflector 22 is covered by a lens 18, which is retained by a bezel 16. Retaining ring 29 secures the parabolic reflector 22 when bezel 16 is threaded onto head 14. An optical filter 53 may be installed on the bezel 16 via the filter ring mount 50 which may be coupled to bezel 16 using a hinged mechanism allowing rapid deployment and removal of the optical filter 53 in an operational environment.

For example, a security personnel posted at a security checkpoint may observe an unidentified vehicle approaching the checkpoint and, failing to slow in the manner expected by the security detail. In response, the security personnel, employing illumination device 10, may position, by way of example, a green optical filter 53 over lens 18 and operate the illumination device 10 in a pulsed mode of operation, and direct the pulsed beam at the driver of the vehicle. The pulsed, filtered beam produced by the illumination device 10 causes visual disruption to the potential target. If the vehicle fails to slow despite the pulsed, filtered beam directed at the driver, the security personnel may rapidly flip the optical filter 53 out of the path of the projected light beam, and, releasing the switch 15, cause the illumination device 10 to operate as a steady beam searchlight. Using the device 10 as a steady beam searchlight, the vehicle, now identified as a target, may be illuminated and the appropriate amount of force needed to neutralize the threat may be employed. In such operational scenarios, the security personnel may be wearing personal protective gear which restricts the motion of the security personnel. For example, gloves or bullet-proof clothing may be worn; such clothing limits manual dexterity. The exemplary embodiment depicted in FIGS. 1-3 facilitates quick conversion of the illumination device 10 from a filtered, pulsed mode of operation to a steady searchlight mode with a minimal need for dexterity and handling of fine items. Procedures that require manual dexterity or require more than one or two seconds, such as turning threaded filters for removal or installation—may prevent the security personnel from accomplishing its mission.

Housed within the body (FIG. 2, 12) a PCB 32 which has mounted thereon, circuitry configured to receive, regulate and control power for the device 10. A heat sink 34 may be provided for conducting heat generated by the PCB 32 away from the circuitry. A processor 41, for example, a microprocessor in a programmable logic device (PLD) is provided, and may be configured to generate signals for controlling other components installed on the PCB 32. A battery 36 may be housed within the body of the device 10 providing internal power for the device 10. The battery 36 has an elongated case with electrical contacts 37 at one or the other end of the battery 36. In another embodiment, the battery 36 may have sliding electrical contacts 39 along a longitudinal side of the battery 36. Access to the battery 36 and/or PCB 32 may be had through a removable end cap 17 (Shown in FIG. 2) installed on the end of body 12 which retains battery 36 and PCB 32 within body 12.

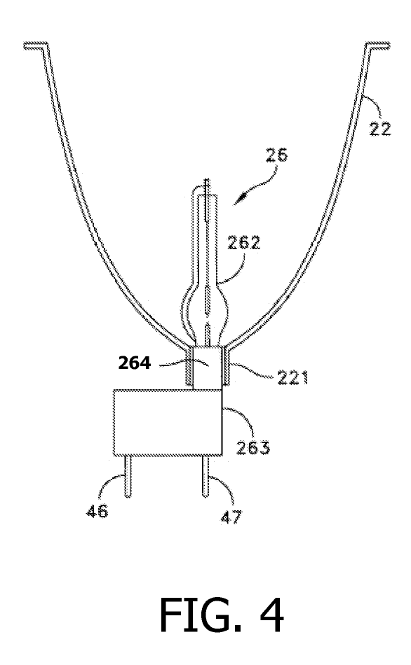

FIG. 4 shows a partial sectional view of the lamp 26 and parabolic reflector 22 assembly along line 4-4 of FIG. 3. The lamp 26 includes a glass envelope 262 in which are encased two electrodes having an arc gap between them. Within the arc gap, a region containing ions which when electrically excited emit photons is provided which emits the high-intensity light beam of the illumination device. The glass envelope 262 is inserted into a collar 264. The collar 264 is connected to a lamp base 263 which has two pin electrodes, an anode 47 and a cathode 46 extending from one end of the lamp base 263. The lamp base 263 is configured to have a geometric shape which mates with a lamp socket assembly such that the lamp 26 may only be inserted in the lamp socket in one direction. Lamp 26 extends through aperture 221 into parabolic reflector 22. Collar 264 fits within aperture 221 having a close tolerance which limits movement orthogonal to the aperture 221, maintaining the position of lamp 26 within the parabolic reflector's 22 optical axis of symmetry. Lamp 26 may be installed within parabolic reflector 22, such that the anode contact at the arc gap within glass envelope 262 is situated closer to aperture 221 (i.e. the narrow end of parabolic reflector 22). This provides a positioning of the full luminance distribution of the arc in the high magnification region behind the focal point of parabolic reflector 22 and concentrates more light generated by the arc lamp 26 in an area of parabolic reflector 22 which provides an increased density of reflected light energy.

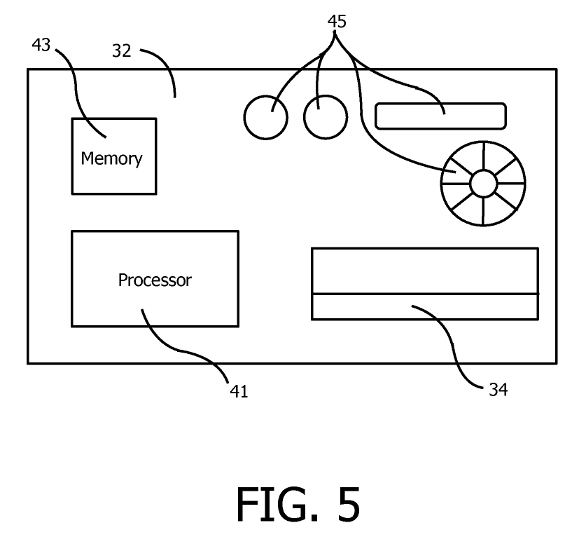

FIG. 5 is a plan view of a printed circuit board (PCB) 32 for use in a multi-function, long range illumination device. PCB 32 comprises a substrate onto which various electrical and electronic components 45 may be electrically connected. Such components 45 may include but are not limited to, resistors, capacitors, inductors, transistors and the like. A heat sink 34 is coupled to PCB 32 and conducts heat generated by the operation of the PCB 32 away from the components 45 installed on the PCB 32. The heat sink 34 may be in contact with the body (shown in FIG. 1 as 12) of the illumination device, which may be constructed from a heat conductive material, for example extruded aluminum, which acts to conduct heat away from PCB 32. A processor 41, for example, a microprocessor in a programmable logic device (PLD) is electrically connected to PCB 32 and provides logic functions for operation and control of the illumination device.

The processor 41 is a processing device which may receive various inputs, perform logical operations on the inputs and generate outputs based on the logical operations. Outputs of the processor 41 may include signals which control the operation of other circuit components 45, which in turn, may perform any of a number of functions associated with the multi-purpose, long-range illumination device, including but not limited to, power conversion and control, lamp power, programmable mode control and other functionality. Processor 41 may perform instructions in the form of software instructions. Software instructions may be stored in processor executable form within memory registers of the processor 41, or software may be stored in another memory 43 installed on the PCB 32. Memory 43 may be in the form of any suitable memory capable of storing software instructions for operating a multi-purpose, long-range illumination device. For example, memory 43 may be read-only memory (ROM), random access memory (RAM), flash memory or other suitable memory. Memory 43 is communicatively coupled to processor 41 through an appropriate data bus (not shown) disposed on the substrate of PCB 32.

Processor 41 may be configured to control circuitry which operates the multi-purpose, long-range illumination device. Circuitry may include, by way of a example, converter circuits, lamp circuits, and igniter circuits. The converter circuit may be configured to provide constant or regulated current at the arc lamp at any power level. The igniter circuit provides a high voltage source for excitation of the plasma within the lamp and across the lamp electrodes. Lamp circuitry controls the intensity level of the lamp via power supply circuit (119 shown in FIG. 1) and may include other functionality such as power supply or battery charging circuits.

The converter circuit may receive power from, for example, an external 12 volt power supply, or by the current of an internal battery 36. The processor 41 provides a RELAY DRIVE signal which controls switching between the internal battery and an external power supply through, by way of example, a double throw—double pole relay. Supply of power from either the internal battery 36 or the external power supply to the illumination device 10 may be controlled through relays between the power source and the illumination device 10. The relays are operated via the RELAY DRIVE signal from the processor 41.

The igniter circuit is controlled by a TRIGGER signal generated by the processor 41. The TRIGGER signal may be used, for example, to provide a trigger to the gate of a transistor. The trigger causes a resistive capacitive (RC) circuit to charge. When a threshold charge is achieved, the RC circuit outputs its charge which may be filtered and conditioned (e.g. by inverter circuits) and coupled to the lamp 26 contacts through a transformer. The RC circuit may be used during ignition of the lamp 26 to deliver power at a constant level even when there is a wide variation in the supply voltage.

The lamp circuitry may be controlled by processor 41 through a HI LO POWER signal which is operative to control the power supply circuit 119. By way of example, the HI LO POWER signal may control the emitter of a transistor coupled to a binary coded decimal (BCD) resistive ladder, to continuously and smoothly digitally control the maximum current supplied to the lamp 26 as the power is adjusted from high to low power and vice versa. By way of example, when an operator momentarily depresses switch 15, the illumination device 10 is turned on. A second momentary closure of switch 15 turns off the illumination device 10. When the switch 15 is pressed for more than a few seconds, HI LO POWER becomes active and the BCD signals begin to count up causing the resistance ladder to be driven to gradually increase power provided by power supply circuit 119.

A more detailed discussion of exemplary circuitry which may be used in a described embodiment may be found in U.S. Pat. No. 6,702,452 issued Mar. 9, 2004, assigned to Xenonics, Inc. of Carlsbad, Calif., which is herein incorporated by reference in its entirety. Processor 41 as described herein refers to any suitable logic device which is capable of receiving inputs and producing outputs based on the received inputs.

Processor 41 may be, but is not limited to, any of the following: a programmable logic device (PLD), a complex PLD (CPLD), field programmable gate array (FPGA), or other microprocessor capable of processing input signals and producing outputs for control of the control circuits.

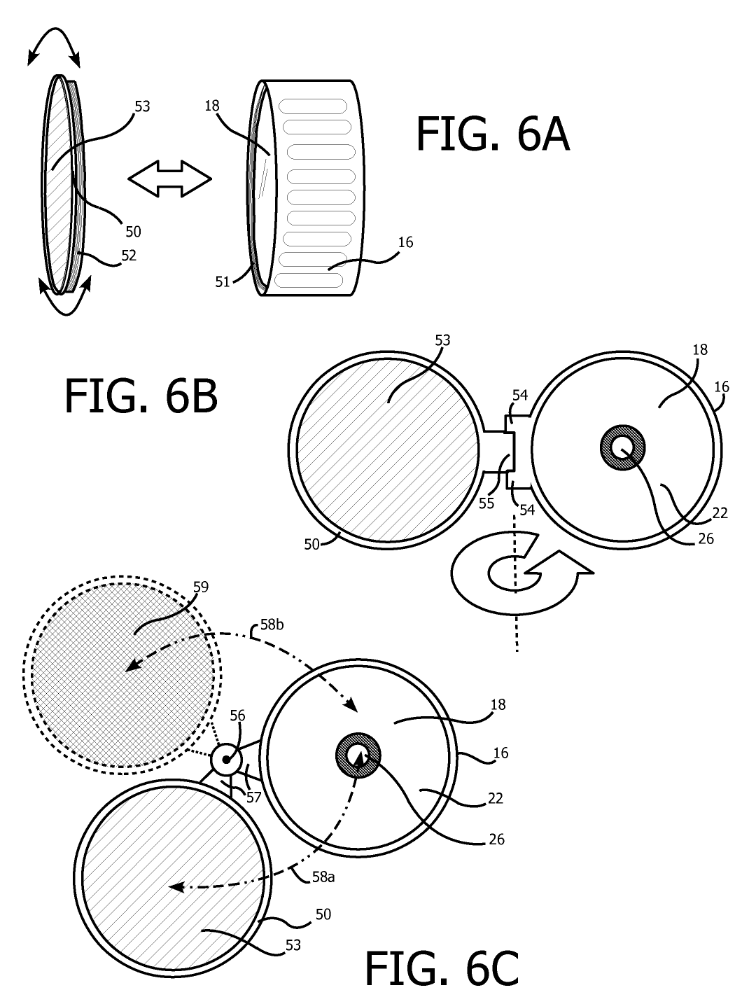

Referring to FIG. 6A, a perspective view of a bezel 16 and a green optical filter 53 assembly of a multi-purpose, long range illumination device which includes a pulsed mode of operation is shown. Bezel 16 is operatively coupled to the head (shown in FIG. 2 as 14) and may be configured to provide focal adjustment of a light beam by providing relative motion of a parabolic reflector 22 with respect to an arc lamp 26 along an optical axis of symmetry of the parabolic reflector 22. Bezel 16 may house a lens 18 through which a generated light beam is directed. Lens 18 may serve to further focus or collimate the projected light beam. Bezel 16 is configured with internal threads 51 at one end of the bezel 16 at a portion of bezel 16 forward of lens 18. A green optical filter 53 composed of, for example, plastic or glass is surrounded by a filter ring mount 50. Filter ring mount 50 engages the edges of green optical filter 53 and provides for attachment of the filter to bezel 16. For example, internal threads 51 may receive external threads 52 incorporated in filter ring mount 50 associated with green optical filter 53. Green optical filter 53 may be threaded onto bezel 16 to completely cover lens 18. As the projected light beam passes through green optical filter 53, some wavelengths of light reaching the green optical filter 53 are blocked while light having wavelengths characterized as green light are permitted to pass through green optical filter 53. For example, the green optical filter 53 may be configured to allow light to pass having a range of wavelengths centered about 532 nm. The green optical filter 53 provides a projected, high-intensity green light beam which causes an uncomfortable or distracting response in a person viewing the projected green beam. For example, the person may respond with an impulse to turn their head to avoid looking at the intense green light. Moreover, when looking at the green light, the viewer may feel confusion or discomfort resulting from overstimulation of the optic nerves. In either case, the operator of the device 10 gains an advantage by placing the opponent off guard and less able to inflict harm on, or defend themselves against, the operator of the device 10. Power to the lamp may be selectively controlled to provide varying intensities of light output. For example, power to the lamp may alternate between a high or low power, resulting in the intensity of light output by the lamp to alternate between a high intensity and a low intensity. The lamp may be configured to oscillate between a high intensity (high power supplied to lamp) or a low intensity (low power supplied to lamp) at a pre-determined frequency, a pulsing or strobe effect and produce enhanced physiological effects.

FIGS. 6B and 6C are elevation views of embodiments of bezel 16 and filter 53 assemblies which may be used to provide a pulsed mode of operation in a multi-function, long range illumination device. FIGS. 6B and 6C show the forward end of bezel 16, looking into bezel 16 in a direction opposite that of a beam being projected out of lens 18. Looking into bezel 16, the lens 18, parabolic reflector 22, and lamp 26 may be seen. As shown in FIG. 6B, a green optical filter 53, which operates as described above with regard to FIG. 6A, is attached to bezel 16 through a hinge mechanism. Green optical filter 53 has a filter ring mount 50 including a tongue member 55 which is inserted between two projecting hinge members 54 integrated into bezel 16. A hinge pin (not shown) passes through projecting hinge members 54 and tongue member 55 to provide an axis of rotation indicated by the block arrow. To implement a dazzler mode of operation, green optical filter 53 is rotated along the axis of rotation defined by the hinge assembly to completely cover lens 18. A latching mechanism (not shown) may be used to retain green optical filter 53 in position covering lens 18. To convert the multi-purpose, long range illumination device, from a pulsed mode of operation, to a searchlight mode of operation, the green optical filter 53 may be rotated along the axis of rotation defined by the hinge assembly to a position such that no part of green optical filter 53 covers lens 18 or blocks the beam emitted by the device. For example, green optical filter 53 may be rotated 180° in relation to the forward end of bezel 16 as shown in FIG. 6b. To ensure that green optical filter 53 remains in a desired position, either being implemented to provide a dazzler mode of operation, or in a standby position allowing for searchlight functionality, a stay mechanism may be employed which holds the green optical filter 53 at a discrete position. For example, detents may be provided between projecting hinge members 54 and tongue member 55 to maintain a discrete position of optical filter 53. The embodiment illustrated in FIG. 6B provides for a rapid deployment or removal of the optical filter 53 in situations were the operator of the illumination device 10 may be wearing restrictive or protective clothing, for example, gloves. The illumination device 10 may be quickly and conveniently converted between modes of operation via a simple physical gesture of engaging retaining ring 40 to flip the optical filter 53 into position to cover the lens 18, or engaging retaining ring 40 to flip the optical filter 53 to uncover the lens 18. Change in operation of illumination device 10 between a steady or pulsed beam may be accomplished through a simple operation of a pushbutton switch 15 requiring only the use of one finger.

FIG. 6C shows another embodiment of a bezel and filter assembly, for rapid conversion of a multi-purpose, long range illumination device from a searchlight mode of operation to a pulsed mode of operation. A central hub 56 defining an axis of rotation is connected to bezel 16 and to filter ring mount 50 which holds optical filter 53 through extension tabs 57 extending from each. The green optical filter 53 is rotatable about the hub 56 along a radial arc 58a extending from the center of green optical filter 53 and the center of lens 18. Green optical filter 53 may be rotated along arc 58a to provide a range of motion allowing green optical filter 53 to completely cover lens 18 when operating in a pulsed mode of operation. Alternatively, green optical filter 53 may be placed in a position where no portion of green optical filter 53 covers any portion of lens 18, as shown in the position depicted in FIG. 6C. An optional second filter 59 may be provided which shares hub 56. The optional filter 59 is rotatable along radial arc 58b which provides a range of motion which allows optional filter 59 to completely cover lens 18. Alternatively, optional filter 59 may be placed in a position where no portion of optional filter 59 covers any portion of lens 18, as shown in the position depicted in FIG. 6c. The optional filter 59, by way of example, may be an optical filter which allows infrared light to pass through the filter 59 but blocks light of shorter wavelengths.

In another embodiment, the optional filter 59 may be an ultraviolet filter that allows only ultraviolet light to pass through the filter 59 or blocks all light of longer wavelengths. To ensure that green optical filter 53 remains in a desired position, either being implemented to provide a pulsed mode of operation, or in a standby position allowing for searchlight functionality, a stay mechanism may be employed which holds the green optical filter 53 at a discrete position. For example, detents may be provided between extension tabs 57 comprising central hub 56 to maintain the position of green optical filter 53 in relation to bezel 16.

The filter and bezel assemblies depicted in FIGS. 6A-6C allow for rapid conversion between modes such as a searchlight mode of operation, infrared night vision mode of operation, or a dazzler mode of operation. This provides a level of operational readiness from a single device allowing a user to detect a potential threat using a searchlight and then delay and slow the threat through rapid implementation of a green strobe which may be directed at the threat to disorient or confuse the threat. The device, while operating in a pulsed mode of operation with a green filter positioned over the pulsing beam, may be pointed directly at the threat because the exact location of the threat is known, having been located through the searchlight mode of operation. For example, a suspicious vehicle approaching a checkpoint, may be illuminated up to a mile away using the searchlight mode of operation of a multi-purpose illumination device. If after attempts to signal the driver to yield or slow down fail, the illumination device may be rapidly converted to a dazzler mode of operation by the user flipping or swinging the green optical filter 53 in front of the lens 18 and directing the high-intensity green beam at the driver's eyes. Additional operational features may heighten the green strobe effect, such as a pulsed or strobe effect implemented through simple and accessible controls which may be implemented through a single pushbutton switch as described herein with regard to FIG. 1.

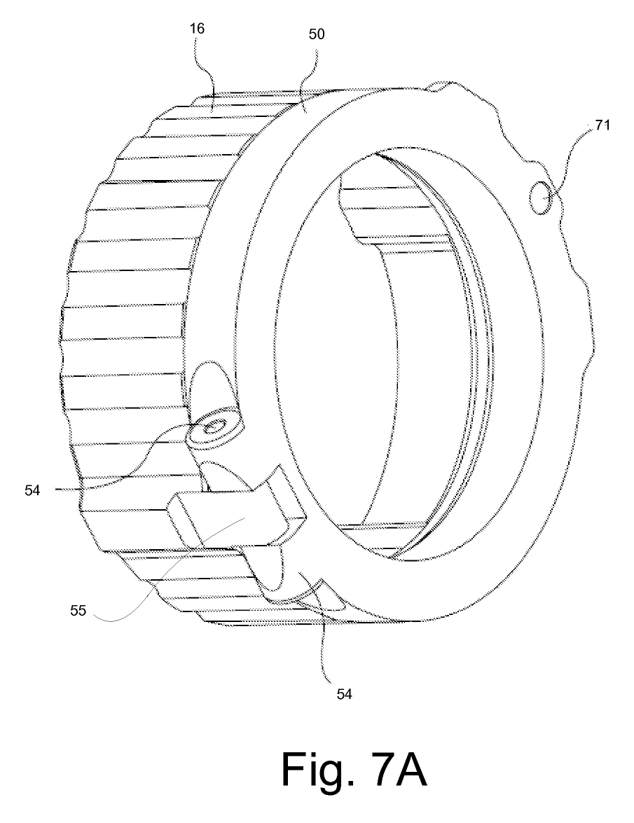

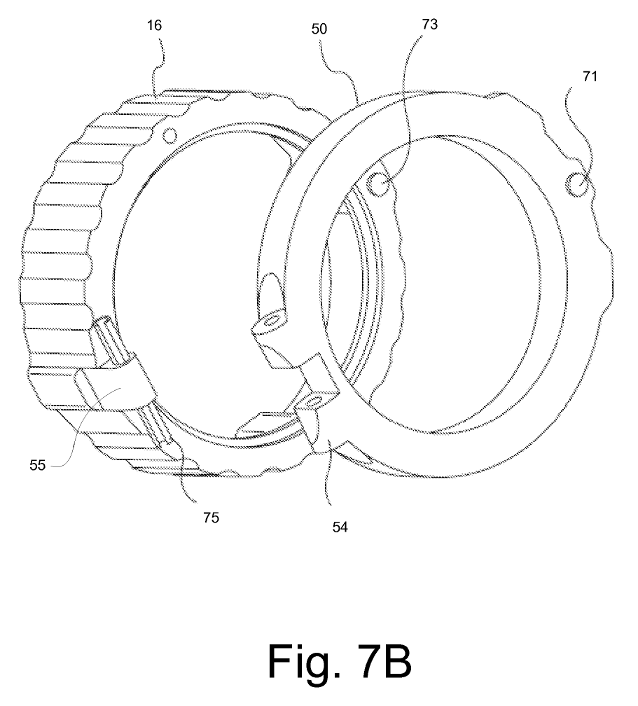

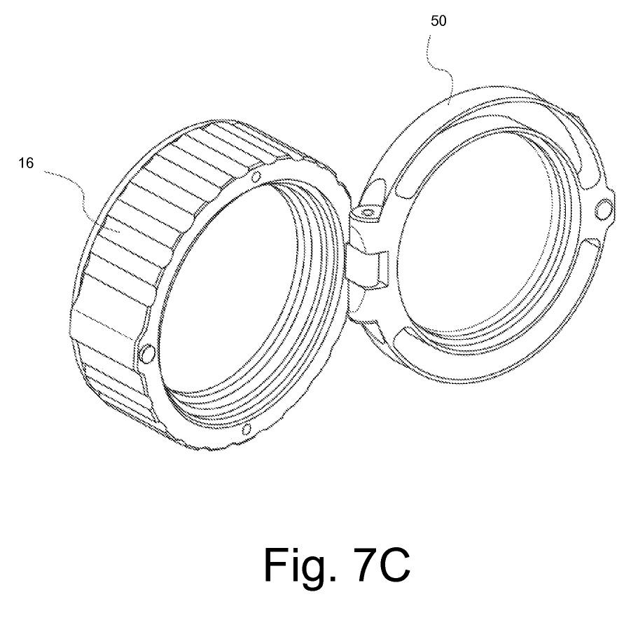

Referring now to FIGS. 7A and 7B, an assembly of a rotatable bezel 16 and filter ring mount 50 is illustrated. Filter ring mount 50 is coupled with rotatable bezel 16 via a hinge member 54. A magnet 71 is mounted in filter ring mount 50. A corresponding magnet 73 (shown in FIG. 7B) is mounted in rotatable bezel 16. In the illustrated embodiment, magnets 71 and 73 may be neodymium magnets and may be cylindrical in shape. Other shapes and magnetic materials, such as other rare earth magnetic materials, may also be used. Magnets 71 and 73 facilitate easy and complete covering of lens 18 with filter ring mount 50 by locking filter ring mount 50 tightly against rotatable bezel 16 thus preventing accidental or unintended movement of filter ring mount 50. A certain magnitude of force is required to overcome the magnetic fields of magnets 71, 73 to unlock or lift filter ring mount 50 off rotatable bezel 16. By way of example, this force may be provided manually and/or via a servo motor (not shown). Filter ring mount 50 may pivot about hinge member 54 in any position between a first position and a second position. In an exemplary embodiment, hinge member 54 may include a spring tension pin 75. Spring tension pin 75 exerts sufficient force upon filter ring mount 50 to maintain any position between and including the first and the second positions and requires application of a predetermined magnitude of force to change the position of filter ring mount 50 relative to rotatable bezel 16. In the first position filter ring mount 50 is at least perpendicular to bezel 16 wherein lens 18 (shown in FIG. 2A) is completely uncovered and is completely outside the path of the high-intensity light beam from lamp 26. According to an exemplary embodiment, filter ring mount 50 may rotate about 180° to bezel 16, wherein optical filter 53 is completely in the path of high-intensity light beam from lamp 26. Thus, hinge member 54 permits filter ring mount 50 a range of motion between the first position and the second position. FIG. 2B illustrates filter ring mount 50 is the first position in which optical filter 53 completely covers lens 18. FIG. 2A illustrates filter ring mount 50 in an intermediate position in which optical filter 53 completely uncovers lens 18. FIG. 7C illustrates filter ring mount 50 at about 180° relative to bezel 16.

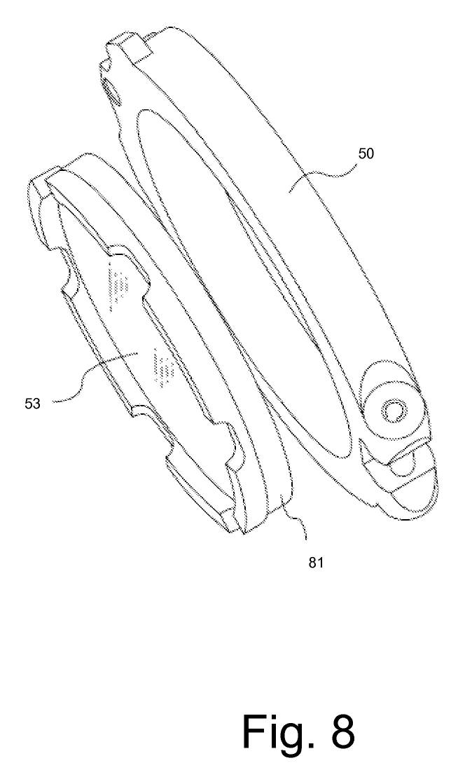

Now referring to FIG. 8, filter ring mount 50 and filter ring 81 are illustrated. Optical filter 53 is mounted in filter ring 81. Filter ring 81 is replaceably mountable in filter ring mount 50. Such an assembly facilitates easy removal and installation of optical filter 53 on illumination device 10 in the field. Optical filters 53 can be easily replaced, if broken, for example, or if a different kind of optical filter is required. The beam output is thus usable with a variety of optical filters to allow varied intensity and wavelengths for a particular application, such as smoke filled environments, infrared illumination and underwater illumination. In an exemplary embodiment, filter ring 81 may have external threads and filter ring mount 50 may have corresponding internal threads. In an alternate embodiment, filter ring 81 and filter ring mount 50 may be configured for removable snap fit of filter ring 81 in filter ring mount 50, so that filter ring 81 is held in place by friction.

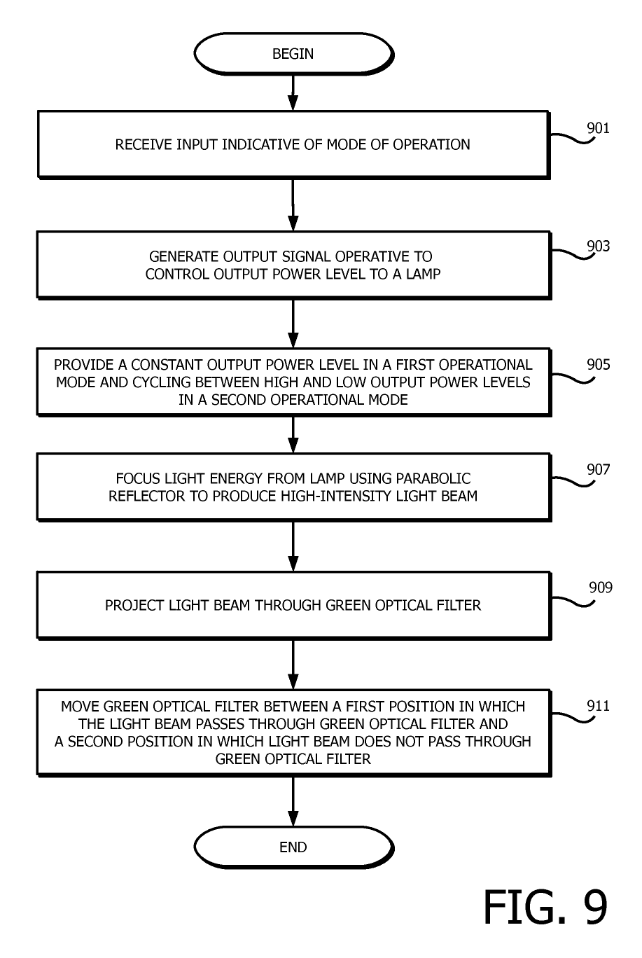

FIG. 9 is a process flow diagram showing a method for operating a multi-purpose, long range illumination system. The process begins by receiving an input signal that is indicative of a mode of operation (block 901). For example, the mode of operation may be a searchlight mode of operation, wherein the illumination system is configured to produce a constant, high-intensity light beam that may be focused to provide a narrow search beam or a wider flood beam pattern. The input signal may be received through a switch disposed on the illumination device which allows a user to operate the switch to select a mode of operation, e.g. continuous or pulsed. The user may utilize the switch to generate an input signal to turn the illumination device on or off, or the user may transmit a signal indicative of the user's desire to enter a pulsed mode of operation. The input signal received from the switch may be a momentary closure of a switch contact, for example, when the switch is momentarily closed and released through use of, by way of example, a pushbutton switch. The input signal is received at a processor and processed to provide an output power signal operative to control circuitry, for example, a power control circuit, which controls the output power level to a lamp (block 903) that provides a high-intensity light source. The lamp may, for example, be an arc lamp, including but not limited to, a xenon arc lamp, or other incandescent or plasma lamp such as mercury-xenon, metal halide, and halogen lamps.

The power supply circuitry provides a constant output power level in a first mode of operation (e.g. searchlight mode). For example, in a searchlight mode of operation, a constant high-intensity light beam is generated by providing a constant high output power level to the lamp. In a second mode of operation (e.g. pulsed mode), the power supply circuitry cycles the output power level between a high output power level and a low output power level (block 905). By way of example, in a dazzler mode of operation, the power supply circuitry may provide a periodic cycling from a high output power level to a low output power level at some predetermined frequency. This cyclic output power level to the lamp causes the light emitted from the lamp to pulse.

The light generated by the lamp is focused using a parabolic reflector positioned around the lamp that directs the light energy from the lamp into a high-intensity light beam (block 907). The light beam is projected through a green optical filter (block 909), which causes the projected light beam to be green in color. The green optical filter may be a bandpass filter that has properties which absorb or block light having wavelengths outside the green portion of the visible light spectrum. The green optical filter may be configured to allow certain wavelengths to pass through the green optical filter, for example, a range of wavelengths centered on a wavelength of 532 nm, while other wavelengths are absorbed or blocked.

The green optical filter is moved between a first position in which the light beam generated by the illumination system is entirely or substantially projected through the green optical filter, and a second position in which the projected light beam does not pass through the green optical filter (block 911).

Based on an input signal received, the selected mode of operation, and the position of the green optical filter, the multi-purpose long range illumination system is convertible from a searchlight mode to a dazzler mode quickly and easily. Transition between modes of operation may be performed in the field using simple inputs from a user. For example, in an embodiment utilizing a push button switch, a user may use one finger to press and release the pushbutton to power the system on or off. While in an on state, pressing and holding the pushbutton may cause the system to enter a pulse mode, or a dazzler mode. Effectiveness of the system in pulsed mode may be enhanced by filtering the output light beam to provide a high intensity pulsing green light. A pulsing green light is known to cause discomfort or disorientation when viewed.

Although the present invention has been set forth in terms of the embodiments described herein, it is to be understood that such disclosure is purely illustrative and is not to be interpreted as limiting. Consequently, without departing from the spirit and scope of the invention, various alterations, modifications, and/or alternative applications of the invention will, no doubt, be suggested to those skilled in the art after having read the preceding disclosure. Accordingly, it is intended that the present invention be interpreted as encompassing all alterations, modifications, or alternative applications as fall within the true spirit and scope of the invention.

What is claimed is:

1. A long range illumination device comprising:
a housing, said housing having an elongated body and a head at one end of said body;
a switch disposed on an outer surface of said housing for receiving an input from a user;
at least one power source for supplying electrical power to said handheld illumination device;
a lamp within said head for producing high intensity light energy;
a parabolic reflector within said head, the parabolic reflector having an aperture, wherein said lamp extends through said aperture into said parabolic reflector, and said parabolic reflector is movable about an optical axis of symmetry relative to said lamp for projecting a high intensity light beam;
an optical filter moveably mounted to said head and configured to substantially cover an end of said parabolic reflector in a first position, and not cover the end of said parabolic reflector in a second position;
a processor in electrical communication with said switch, configured to receive at least one input signal and produce an output power signal; and
a power supply circuit in electrical communication with the processor, configured to, responsive to the output power signal, to provide an output power level to said lamp based on the input signal.

2. The long range illumination device of claim 1, wherein said optical filter is movably mounted to said head by a hinge.

3. The long range illumination device of claim 1, wherein said power supply circuit is configured to produce one of a constant output power level or an output power level that cycles between a high output power level and a low output power level.

4. The long range illumination device of claim 3, wherein the predetermined frequency is between 13 and 30 hertz.

5. The long range illumination device of claim 4, wherein the predetermined frequency is 15 hertz.

6. The long range illumination device of claim 1, wherein said green optical filter is a bandpass filter which allows a range of wavelengths to pass through said green optical filter centered at a wavelength of 532 nanometers.

7. The long range illumination device of claim 6, further comprising a bezel coupled to said parabolic reflector, said bezel providing relative movement between said parabolic reflector and said lamp when said bezel is rotated about said body.

8. The long range illumination device of claim 1, wherein said lamp is a xenon arc lamp.

9. A method for providing long range illumination comprising:
receiving an input signal indicative of a mode of operation;
generating an output power signal, the output power signal operative to control an output power level to a lamp;
providing a constant output power level to said lamp in a first mode of operation, and cycling the output power level at a predetermined frequency, between a high output power level and a low output power level in a second mode of operation;
focusing light energy from said lamp with a parabolic reflector to provide a high intensity light beam;
projecting the high intensity light beam through an optical filter when said optical filter is in a first position, and projecting the high intensity light beam unfiltered when said optical filter is in a second position.

10. The method of claim 9, further comprising projecting the high intensity light beam through said optical filter when in said second mode of operation and projecting the high intensity light beam unfiltered when in said first mode of operation.

11. The method of claim 9, further comprising projecting the high intensity light beam through a green optical filter when in said second mode of operation.

12. The method of claim 9, wherein the predetermined frequency is between 8 and 30 hertz, inclusive.

13. The method of claim 12, wherein the predetermined frequency is between 13 and 30 hertz, inclusive.

14. A handheld illumination device comprising:
a housing comprising an elongated body and a head portion at an end of said body;
a switch disposed on an outer surface of said housing and being electrically coupled to a contact within said housing;
a processor within said housing, in electrical communication with said switch, configured to receive at least one input signal indicative of a mode of operation, and responsive to said at least one input signal, generate an output power signal ;
a power supply circuit, in electrical communication with said processor, and responsive to said output power signal, configured to provide an output power level to said lamp based on said mode of operation;
at least one power source in electrical communication with said processor for supplying electrical power to said handheld illumination device;
a lamp in electrical communication with said power supply circuit, configured to produce a high intensity light;
a parabolic reflector having an aperture, and positioned around said lamp extending through said aperture, wherein said parabolic reflector is movable along an optical axis of symmetry of said parabolic reflector with respect to said lamp; and
an optical filter moveably mounted to said head portion and configured to substantially cover an end of said parabolic reflector in a first position, and not cover the end of said parabolic reflector in a second position.

15. The handheld illumination device of claim 14, wherein said optical filter is moveably mounted to said head by a hinge.

16. The handheld illumination device of claim 14, said power supply circuit configured to produce one of a constant output power level or an output power level that cycles between a high output power level and a low output power level.

17. The handheld illumination device of claim 16, wherein the output power level cycles between the high output power level and the low output power level at a predetermined frequency.

18. The handheld illumination device of claim 17, wherein the predetermined frequency is between 13 and 30 hertz.

19. The handheld illumination device of claim 14, wherein said green optical filter is a bandpass filter which allows a range of wavelengths to pass through said green optical filter centered at a wavelength of 532 nanometers.

20. The handheld illumination device of claim 19, wherein said bezel is coupled to said parabolic reflector, providing relative movement between said parabolic reflector and said lamp when said bezel is rotated about said body.
